(19) United States
(12) Patent Application Publication
(10) Pub. No.: US 2022/0023983 A1
(43) Pub. Date: Jan. 27, 2022

(54) Flange Bolting Management System And Method

(71) Applicant: Ronald C. Clarke, Phoenix, AZ (US)

(72) Inventor: Ronald C. Clarke, Phoenix, AZ (US)

(21) Appl. No.: 17/382,302

(22) Filed: Jul. 21, 2021

Related U.S. Application Data
(60) Provisional application No. 63/054,297, filed on Jul. 21, 2020.

(51) Int. Cl. B23P 19/06

(52) U.S. Cl. CPC B23P 19/067

(57) ABSTRACT

A lock ring tightening mechanism includes a rotary pawl carrier disposed in a radial guide track and moveable by a piston connected to the rotary pawl carrier and a ratcheting lock ring configured for rotational actuation in a tightening direction by actuation of the rotary pawl carrier by the piston. A return spring is configured to return the rotary pawl carrier to a starting position and wherein repeated rotational actuation of the ratcheting lock ring serves to maintain tension in a fastening

### CROSS-REFERENCE TO RELATED APPLICATIONS

This application claims priority to provisional patent application 63/054,297 filed Jul. 21, 2020, which is incorporated herein in its entirety.

### FIELD OF INVENTION

This invention generally relates to bolting installation and management systems.

### BACKGROUND OF THE INVENTION

Fasteners are used in a wide variety of industrial installations where achieving proper fastener loading (tension) and maintaining this loading in service can be problematic. Many industrial fastening applications require a predetermined loading at installation and periodic monitoring of loading to ensure that loading remains within an acceptable range. Maintenance or checking the loading with a torque wrench typically requires retorquing of the fasteners. This is particularly onerous with large fasteners requiring heavy torqueing tools in often difficult to reach locations.

Overtightening a fastener can lead to catastrophic failures. Conversely, fasteners typically experience some loss of tension in service due to, for example, a variety of in-service occurrences including: relaxation (thread embedment), vibration loosening, compressive deformation in the joint or flange, temperature expansion or contraction, etc. Loss of tension from these occurrences can cause misalignment or premature wear in a bolted assembly, leakage (in applications where the fastener is used for sealing), or catastrophic joint failure due to excessively high loads on other members of the assembly.

In certain applications, knowledge of a fastener load, upon installation and over time, is desirable for avoiding the potentially dangerous consequences of a compromised or loosened fastener, such as slippage, wear, leakage and/or possible failure. In other applications, for example when working with a group of bolts around a flange of a sealed assembly, it is important to evenly tighten the group of bolts. By uniformly tightening a group of bolts or studs to an appropriate load, and maintaining this load over time, potential failures are less likely to be experienced.

Hydraulic bolt tensioners, and hydraulic nuts, are all operated by applying the appropriate pressure and then manually turning down a ring nut, termed a lock ring, against the cylinder body face, to retain the threaded piston position, before hydraulic tensioning pressure is removed. This lock ring then supports the bolt load after the hydraulic pressure is removed. This lock ring is not required nor designed with conventional wrenching flats for conventional torqueing but has holes for manual positioning, using a tommy bar. Given the large number of fasteners in large industrial flange installations, such as in refineries, mills, and pipelines, such manual installation and maintenance often proves prohibitive due to the degree of manual labor, downtime, and expense involved.

Large ore grinding mills typically include multiple flanged sections, that are easier to transport and put together at site with bolts or studs. On such large mills, fasteners generally referred to by the OEM's as “rotating”, are manufactured to handle the unique loads encountered by mill shell flanges. Flange bolts are required to operate and stay within their designed preload ranges or else corrosive slurry from within the mill gradually penetrates and separates the flanges wherever they are loose. As this condition worsens, repeated bolt breakages and flange hole damage will result unless corrective action is taken to prevent further separation and slurry erosion. Of course, as mills age, they become more susceptible to this condition and there are many leaking mills all over the world—making flange bolt maintenance essential.

A common corrective method is to include heavy helper plates into the joint alongside each repair section face with longer bolts to pull the flanges together. The helper plates are sized to span the leaking sector which can be as many as a dozen bolts. On a thirty-foot diameter mill, these will become heavy plates. The mill must be shut down to retorque these bolts and often, bolt breakages occur because operators push the amount of up time, leaving some bolts running with insufficient preload for too long of periods, leading to failures. In time, these inadequate, temporary measures can compromise mill integrity and economy and require replacement of shell sections, leading to extended periods of costly down time.

Accordingly, improvements are sought and now available to remotely monitor in real time and then perform quick and efficient maintenance on fastener preloads in flanged assemblies.

### SUMMARY OF THE INVENTION

While the way that the present invention addresses the disadvantages of the prior art will be discussed in greater detail below, in general, the present invention provides a system and method for quickly and accurately restoring fastener preloads, especially in bolted mill flanges.

In some embodiments, an automatic tensioner includes a remote lock ring tightening mechanism with applications in critical flange monitoring and maintenance, e.g., in remote areas such as pipelines, and booster stations. In rotary applications such as SAG and ball mill, operations are brought to a standstill for an extended time to make manual checks and tighten each bolt individually. With the present invention, after standstill, rotating platforms need only the time taken to connect one hydraulic and pneumatic quick connect fitting and initiate an automatic five minute or less tightening cycle to complete maintenance of the flange and be ready for restart. For fixed installations, the automatic fastening maintenance system can be permanently connected with hydraulic power and other auxiliaries to access the tensioners manually or remotely on demand. In some cases, flange bolt loading is continuously monitored in real time using wireless probes. When fastening maintenance is required, the system can be operated remotely to control and automatically perform the maintenance/tightening process.

During tightening, using air pressure, a piston strokes forward pulling a pawl carrier in a radial guide track to drive a ratchet lock ring in a tightening direction. The degree of torque applied to the lock ring can be adjusted by varying cylinder air pressure. A return spring is configured to bring the piston back and reset the pawl to the starting point. The connecting link pulls the pawl carrier to drive a ratchet which is machined into or otherwise attached to the lock ring. “Drag back” of the ratchet lock ring, if any, is limited by a spring-loaded detent mechanism at the ring periphery. To unscrew the lock ring, the pawl can be locked in the disengaged position. Wireless load value transmitters on each bolt will communicate with the mobile power cart software. Automatic or manual, tightening cycle options on the mobile power cart will supply the preset hydraulic pump pressure and air piston movement to tension each bolt simultaneously for uniform flange tightening.

The air piston strokes alternately forward and reverse to each end of the cylinder. A connecting link, in turn, pulls and pushes the rotary pawl carrier, to drive the ratchet, which may be integral to the lock ring. Force on the pawl carrier is controlled by air pressure to the cylinder. Ratchet drag back is limited by the detent mechanism. Manual and/or software-controlled valving on the power trolley will control the piston back and forth, cycling to perform the flange management functions.

In one embodiment, a jack-mounted ratchet/pawl drive is configured with a simple spring loaded “torque pack” to bias the lock ring, so that it may only rotate on direction, e.g., clockwise, when free to do so, to always stay flush with the load face of the jack body. In addition to a loaded spring, the pawl can be driven using pneumatic or electric power in various configurations, to turn the lock ring/ratchet. In some embodiments, multiple lock rings can be simultaneously turned, e.g., along the periphery of a rotating mill A ratchet and pawl system is driven by a spring-returned single-acting or double-acting air cylinder.

Hydraulic cylinders are made integral with or machined into helper plates. The cylinders are hydraulically connected through oil holes drilled into the helper blocks and are pressurized by a shared zerk at both helper plate ends. In case of breakage of a bolt or stud, causing danger as a flying projectile, the broken ends are restrained by limiting blocks attached to the helper plates.

Wireless monitoring may serve to trigger warnings when the load on a bolt drops below a threshold or to zero, indicating a loose or broken condition, so that corrective action can be taken when time permits. Thus, mill flange assemblies may be continuously monitored to maintain flange preloads to prevent leakages. In some embodiments, wireless, state-of-the-art fastener load monitoring and processing allows mill operators to track individual bolt loads in real time, to efficiently schedule maintenance. Uniform force along the full flange repair face as against single bolt tightening is desirable

In some embodiments, a zerk hydraulic quick connect serves several cylinders from one or either side of a multi-bolt flange management system. This manifold approach reduces maintenance cycles to minutes instead of hours, by simultaneously tightening all ganged bolts back to initial assembly preload.

In some embodiments, safety is enhanced by configuring tensioning assemblies such that no parts can detach from or fly away from the rotating mill if a bolt breaks. Additional safety is provided through the absence of hydraulic high pressure hoses and fittings as all oil passages are drilled directly in the helper plates. Proper, timely maintenance will prevent leakage, flange separation and slurry flow erosion. Reduction of manpower requirements and reduction of the need for heavy torqueing tools afford further safety gains.

In some applications, a single operator/technician may perform routine maintenance as outlined below. A hydraulic hose with a quick connect fitting and a pneumatic snap, e.g., from a mobile power trolley on the platform, interfaces the repair flange section at mill shut down. The mill need not be positioned or jogged to perform this maintenance. An important advantage is that the extended hydraulic power hose and air line can access the mill repair hydraulic zerk at any random radial standstill point. The computer on the trolley communicates with the wireless bolt load transmitters while the graphical user interface displays the controlling program and a software graphical representation of the bolt locations with corresponding load values. Optional manual or fully-automatic software-controlled tensioning cycles can be initiated.

One example of a basic cycle operates as follows: all the individual fasteners, through their “in-joint” tensioners, are simultaneously pressurized through the internal oil hole/channel drillings and are held to a preset hydraulic pressure by the pump on the trolley. The bolts will stretch under the preset pressure, e.g., to 80% yield, so that the load bearing face of the lock rings will now move away from the jack bodies and come loose. Pneumatic tensioning cycles will then initiate to turn and screw the lock rings back to the jack faces. Hydraulic pressure is then removed and current individual bolt load target values verified. If required, the cycle may be repeated till all bolt target window values are achieved. For quality assurance, the performed maintenance procedures and resulting compliance will be electronically monitored and recorded on completion. Ideally, a tightening cycle could take as little as a few minutes to complete.

In some embodiments, both plates are clamped between Bellvilles, against the flange, with a fine pitch auxiliary nut on a larger than standard bolt body diameter, ahead of the smaller standard main thread diameter nut. The main round nut and threads is designed to fully tension the bolt to joint load specifications. A breakaway notch on the smaller diameter, machined after the auxiliary nut, will make this the designated fracture point so that when the main nut separates it will stay in the nut catcher while the rest of the assembly is held in place axially by the lightly preloaded auxiliary nut.

A single hydraulic quick-connect zerk, a pneumatic snap, and an electric power plug from a GUI-equipped mobile power trolley interfaces with the flange at shut down. A fully-automatic software-controlled tensioning cycle is initiated, in which the individual fasteners, are simultaneously loaded to the same hydraulic pressure, developing around 80% of bolt yield. Pneumatic cycle will then hold full designed pressure (torque) on the lock rings with the air pistons cycling back and forth a few times. Hydraulic jack pressure is then removed and if necessary, the cycle can be repeated until all bolt target load window values are achieved. Manual control will also be available. Maintenance procedure and resulting compliance can be electronically monitored and recorded on completion for quality assurance.

A single zerk can be used to pump ganged jacks through a manifold plate/delivery configuration. The ganged jacks can then be tightened to target a value—regardless of previous individual tightness. As all the bolts pull up and stretch, the lock rings will come loose and springs will turn the ring down and lock. Automatic pump cycle tightens jacks/flange up to predetermined load (e.g., 70-75 of yield). The jack lock ring can be manually tightened after jack pumping and initial installation loading. Subsequently, operators will preload springs against lock rings by using a click torque wrench, to set uniform spring force of 80-100 ft*lbs. of spring torque. The lock ring can then compensate/absorb any gap (through small rotation) formed during subsequent target value loading after observed load losses e.g., through embedding, wear, etc.)

The lock ring only turns under preload to quickly reset lock ring position to close gap created during subsequent maintenance loading when jack is repumped to installation preload. The lock ring does not serve to “load” the bolt, but simply serves to lock the jack at the loaded position. Avoid manual closing of the gap with the lock ring during maintenance. Could be several thousandths gap develop during each maintenance cycle, so one torque ring preload could suffice for multiple, e.g., 6-12 jack reloading cycles—potentially the life of a liner—or at least between general maintenance shutdown periods.

Prior conventional manual installation and maintenance requires heavy torque wrenches and reaction wrenches/tools, scaffolding, and safety belts none of which is required with this system. The flange manager avoids unnecessary risks to maintenance personnel.

Clamp plates can be bolted to the jack to prevent turning and connect the jack with a grommet/O-ring to the oil line/passages in the plates. Flexible braided high-pressure oil lines extend between zerk manifold blocks along the flange, e.g., using quick disconnects, thus any number of jacks may be hooked to a common zerk, e.g., 5-20.

A series of rings and seals may be used to prevent intrusion of slurry into the fastening, e.g., Belleville pressure rings or annular seal pressure rings. O-rings, not shown, may be installed between jack body and jack piston interfaces.

A deliberate undercut may be formed under a threaded head to ensure any breakage happens at that location. A damper spring may be used to quiet and contains a broken nut within a nut catcher. Thus even broken fasteners are retained by the flange management system.

The details of one or more implementations of the invention are set forth in the accompanying drawings and the description below. Other features, objects, and advantages of the invention will be apparent from the description and drawings, and from the claims.

### BRIEF DESCRIPTION OF THE DRAWINGS

A more complete understanding of the present invention may be derived by referring to the detailed description and claims when considered in connection with the Figures, wherein like reference numerals refer to similar elements throughout the Figures, and

FIGS. 1, 2, 3, 4, 5, 6, 7, 8, 9, 10, 11, 12, 13, 14, 15, 16, 17, 18, 19, 20 and 21 show various views of flange fastening management systems according to several embodiments.

Like reference symbols in the various drawings indicate like elements.

### DETAILED DESCRIPTION

The following description is of exemplary embodiments of the invention only, and is not intended to limit the scope, applicability or configuration of the invention. Rather, the following description is intended to provide a convenient illustration for implementing various embodiments of the invention. As will become apparent, various changes may be made in the function and arrangement of the elements described in these embodiments without departing from the scope of the invention as set forth herein. It should be appreciated that the description herein may be adapted to be employed with alternatively configured devices having different shapes, components, mechanisms and the like and still fall within the scope of the present invention. Thus, the detailed description herein is presented for purposes of illustration only and not of limitation.

Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

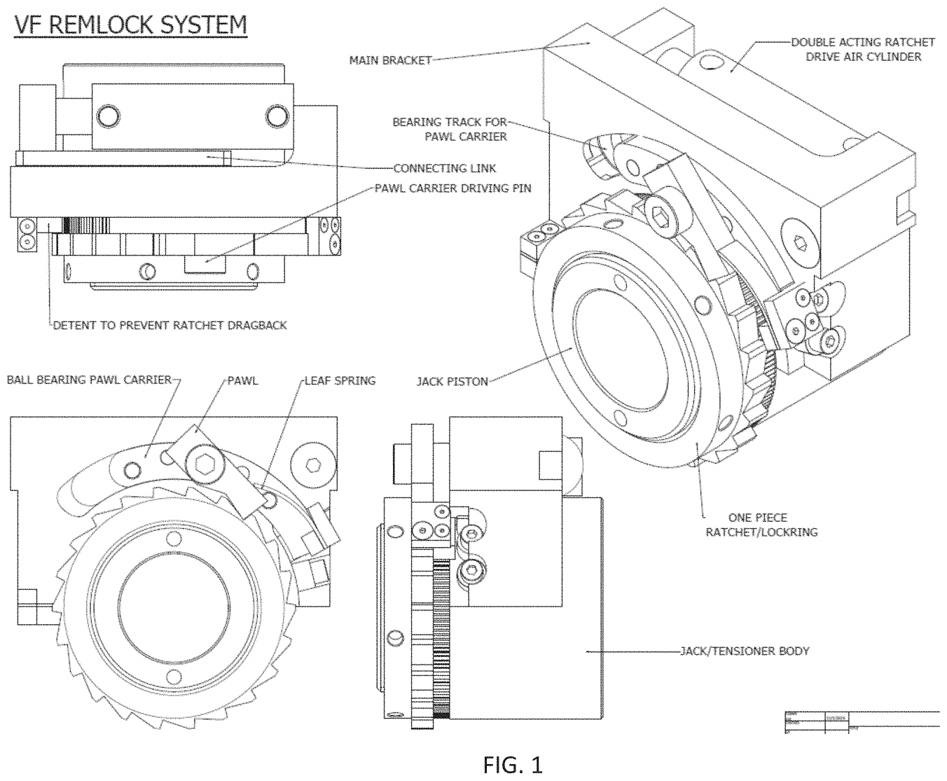

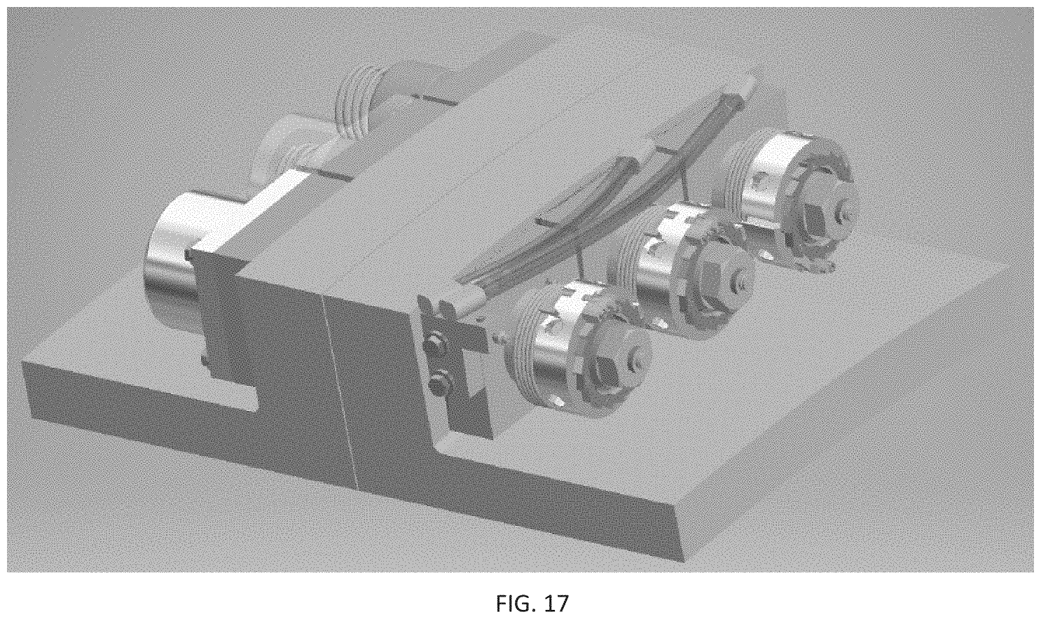

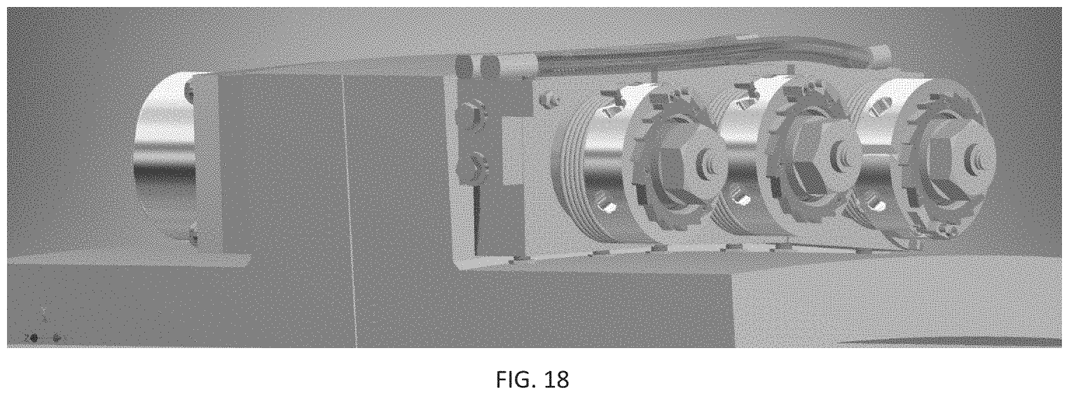

FIGS. 1-20 illustrate different views of a fastening management system according to various embodiments.

With reference to FIG. 1, a fastening management system includes a jack tensioner body supporting a ratcheting lock ring, pawl, ratchet drive, and jack piston.

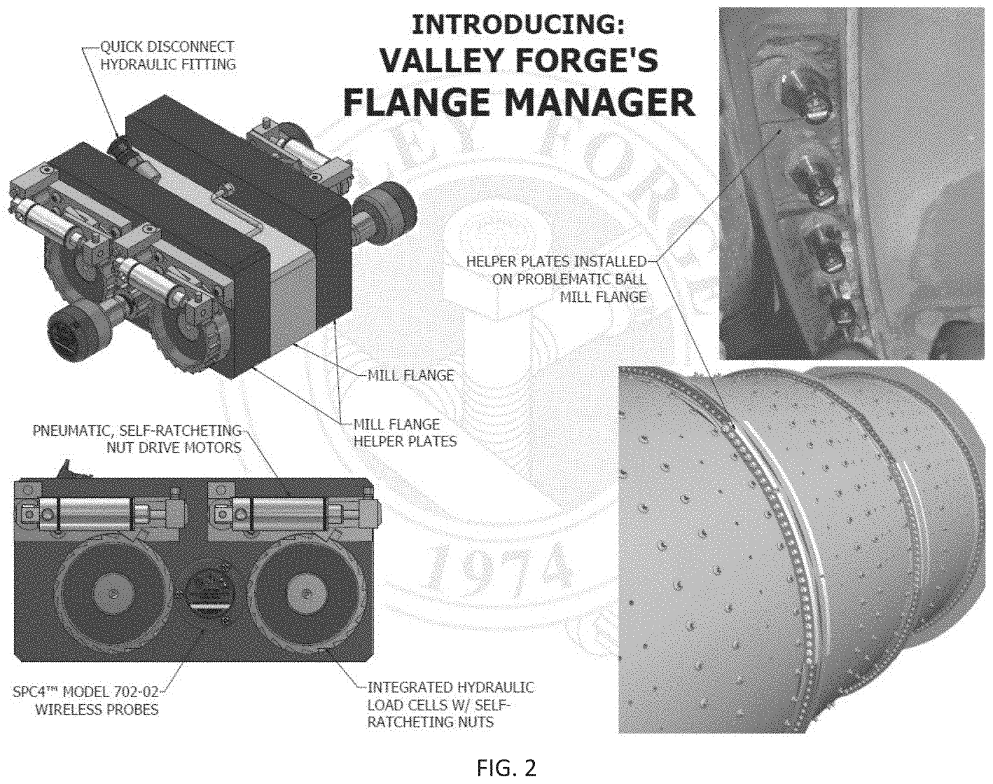

With reference now to FIG. 2, a fastening management system is shown for use with helper plates on a rotating mill application, including use of quick-connect hydraulic fittings, SPC4 wireless probes, and integrated hydraulic load cells.

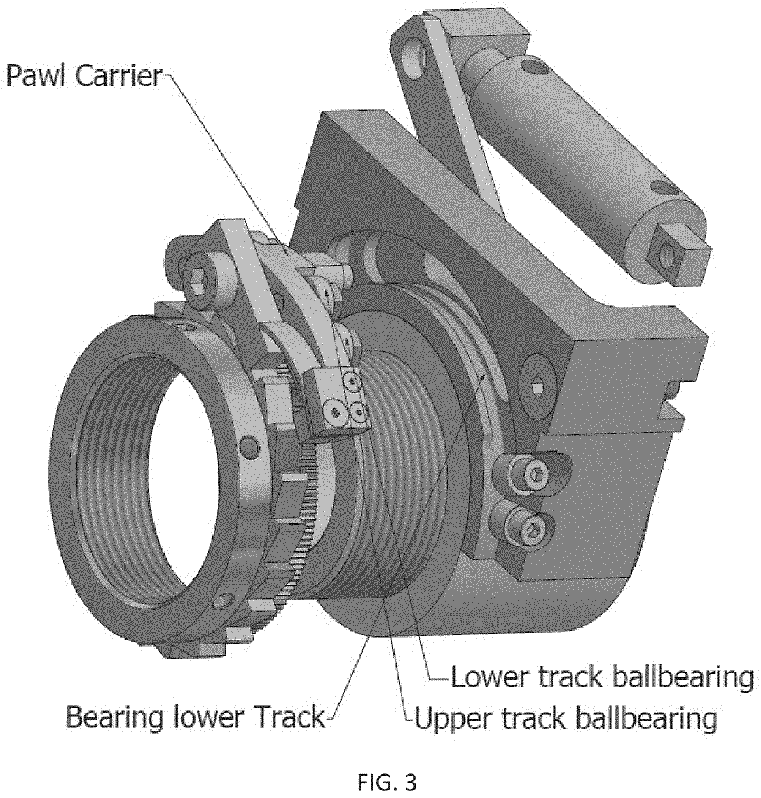

With reference now to FIG. 3, a connection link is shown for use with the ratchet actuator according to one embodiment.

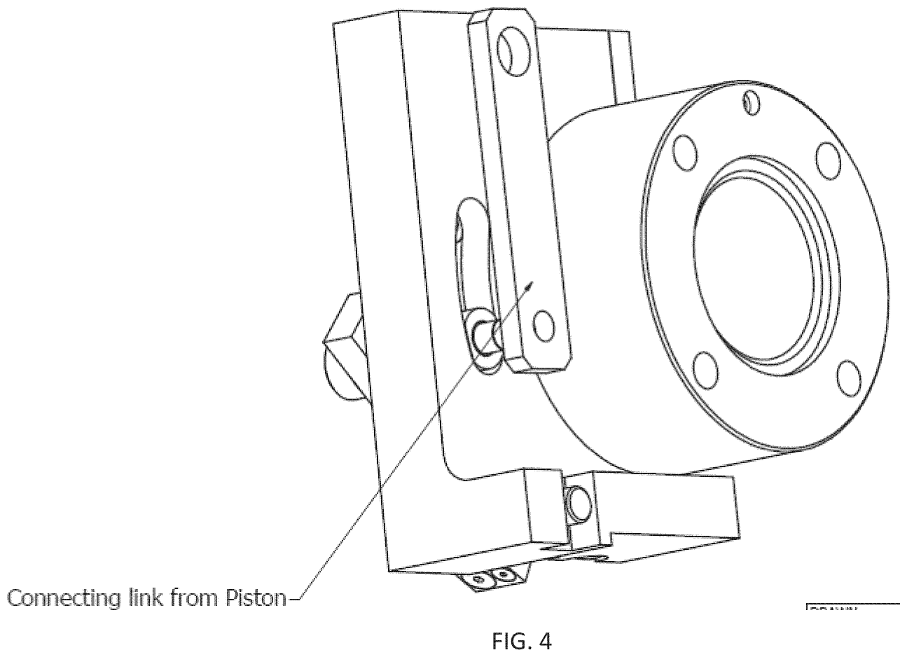

With reference now to FIG. 4, a pawl carrier and bearing tracks are shown for use with the ratcheting lock ring according to one embodiment.

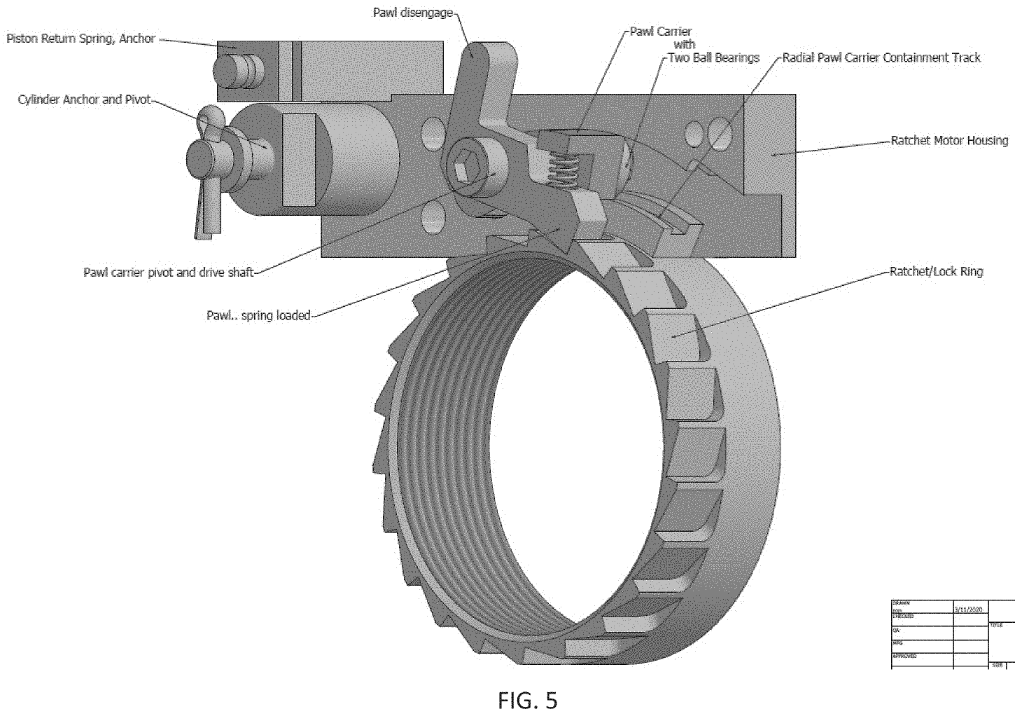

With reference now to FIG. 5, components of the ratcheting lock ring and pawl are shown according to one embodiment.

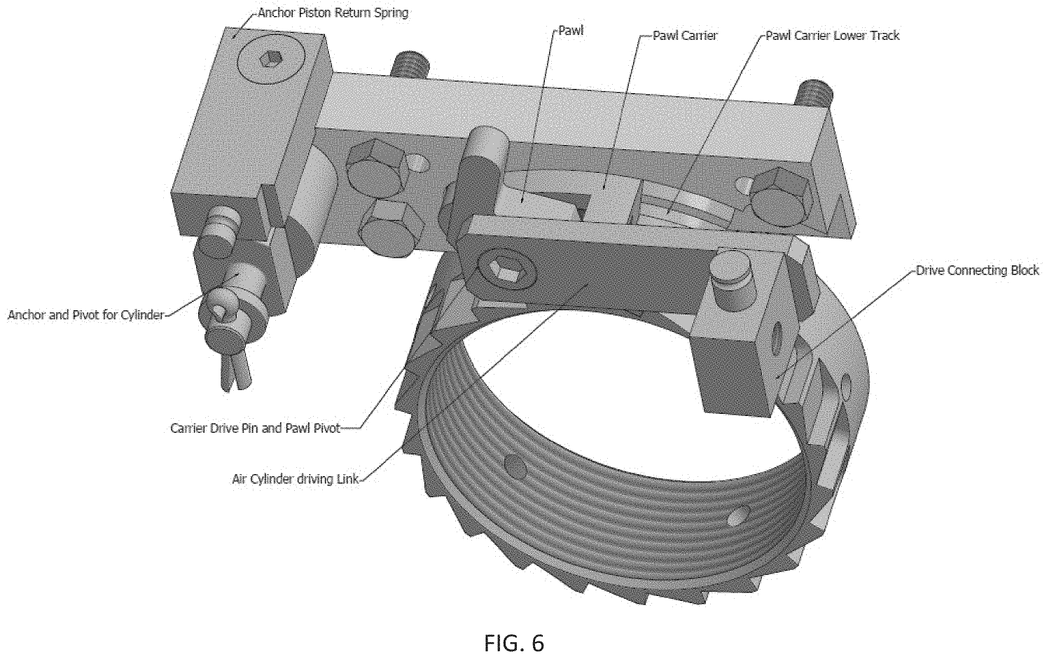

With reference now to FIG. 6, components of the ratcheting lock ring and pawl are shown according to one embodiment.

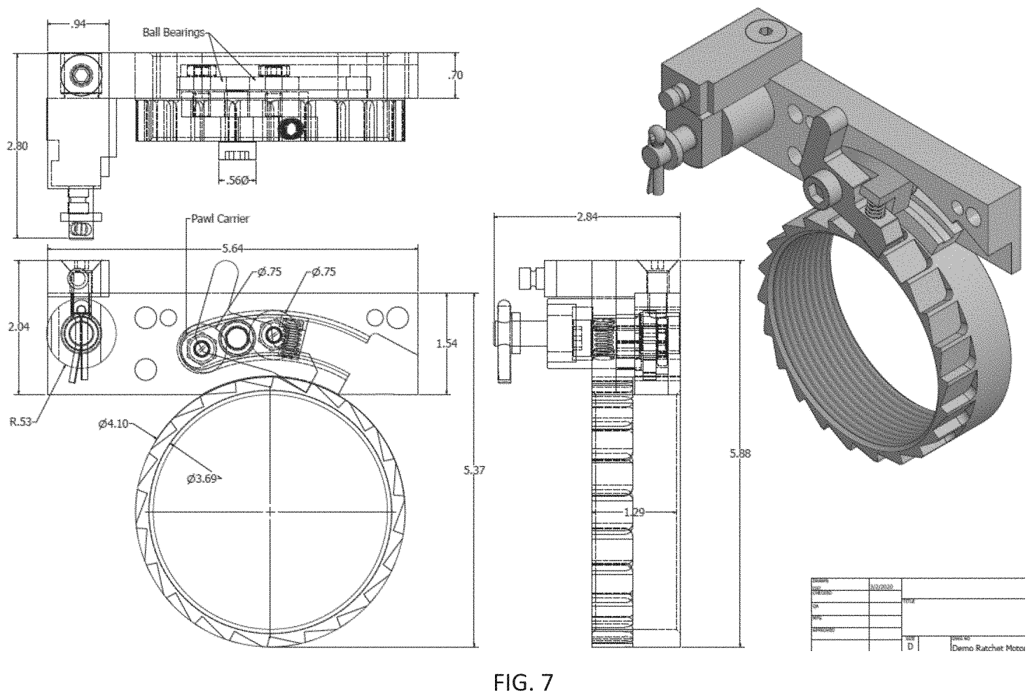

With reference now to FIG. 7, components of the ratcheting lock ring and pawl are shown according to one embodiment.

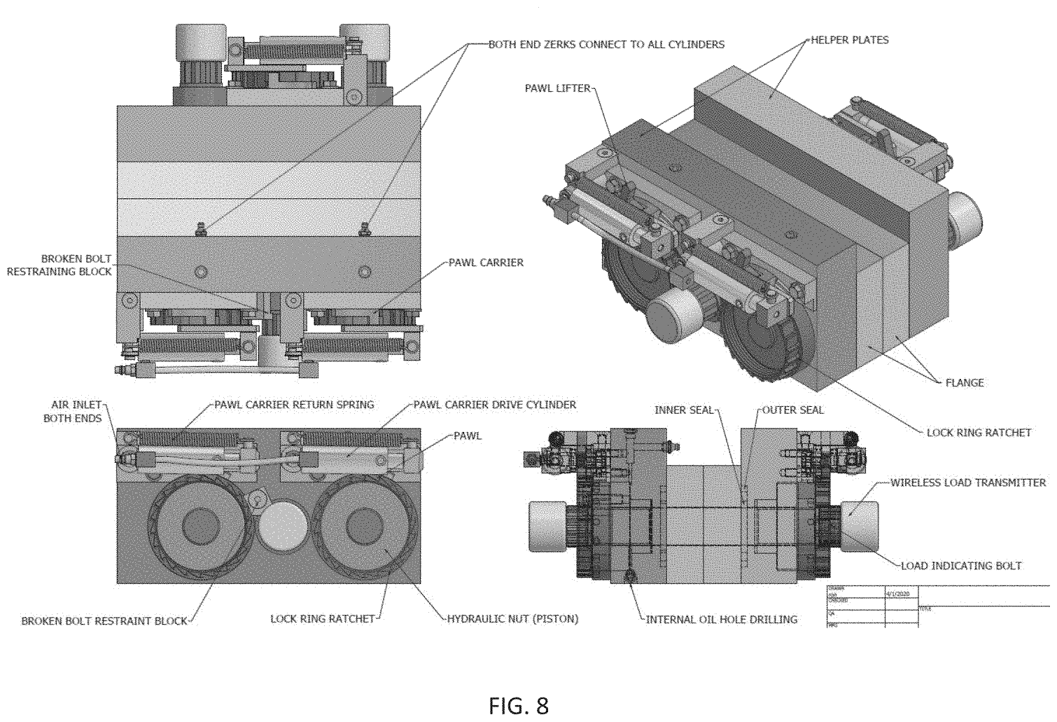

With reference now to FIG. 8, broken bolt retaining blocks, helper plates, load indicating bolts, wireless load transmitter, and air and oil channels are shown according to one embodiment. Load indicating fasteners are described in U.S. Pat. No. 8,024,979 to Ronald Clarke, which patent is incorporated herein in its entirety by reference.

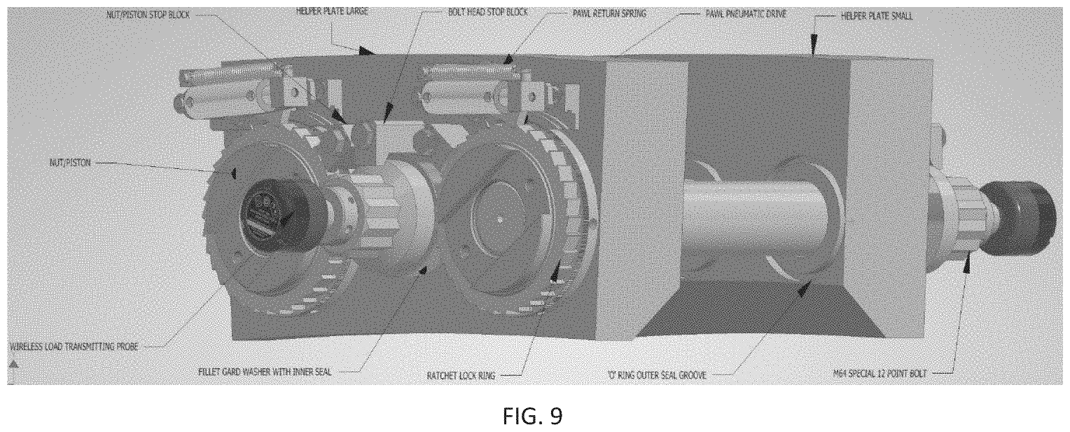

With reference now to FIG. 9, components of the fastening management system are shown according to one embodiment, in which M64 12 pt bolts with wireless transmitting probes are used.

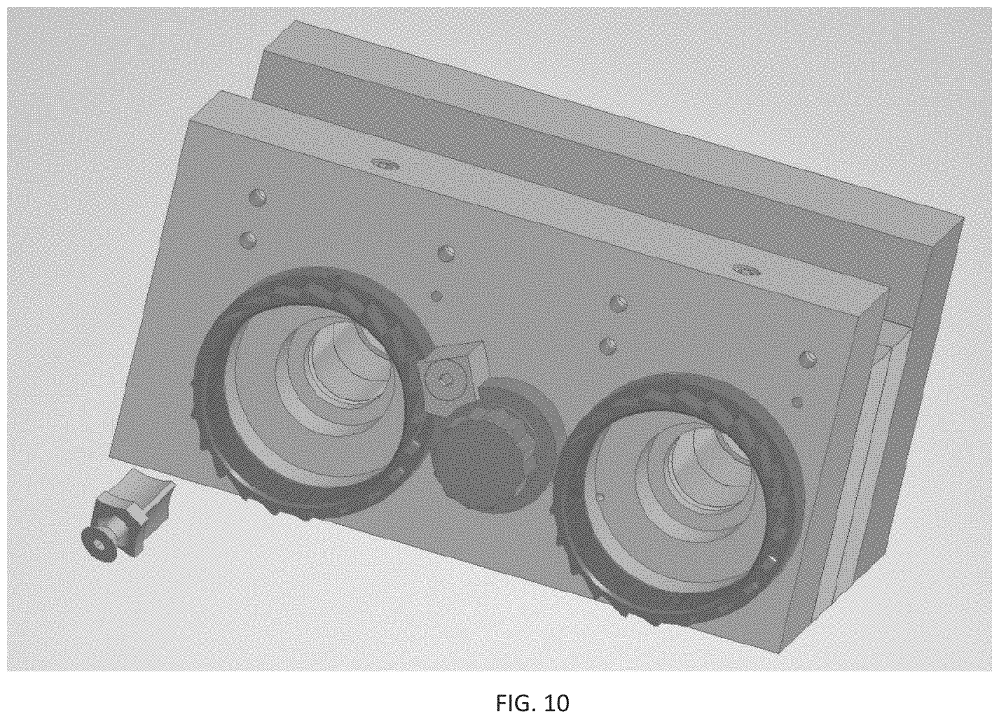

With reference now to FIG. 10, a pair of ratcheting lock rings is shown according to one embodiment.

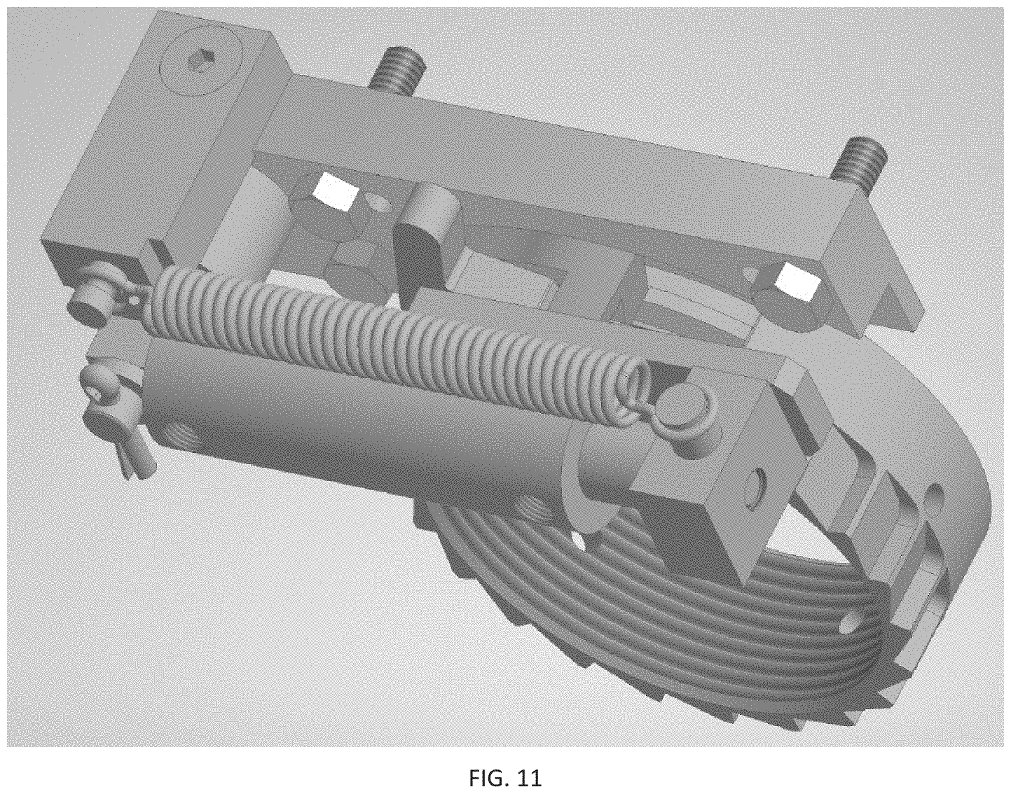

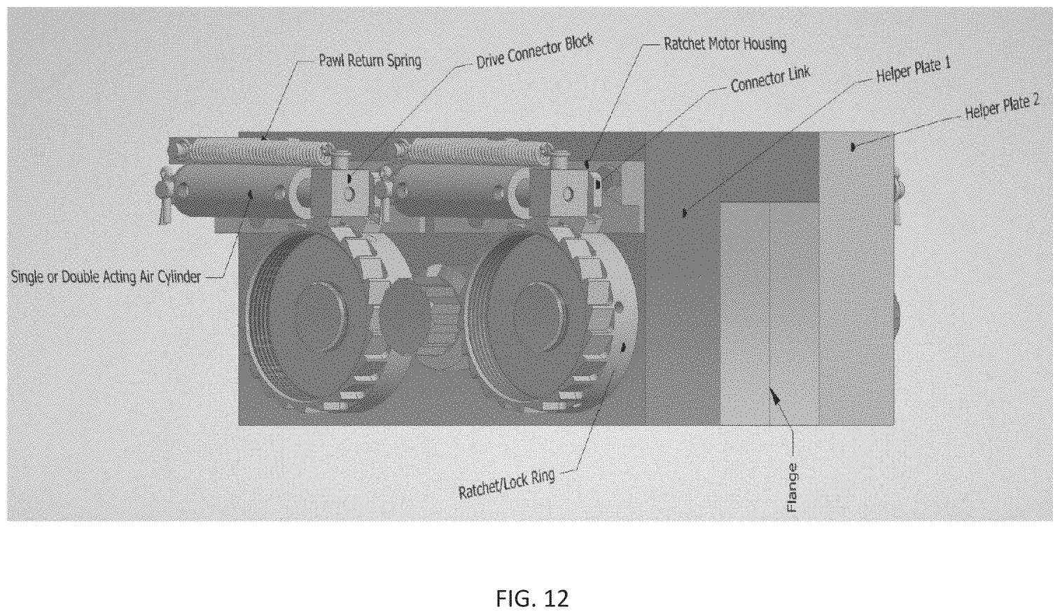

With reference now to FIGS. 11-12, a ratchet pawl, actuator, pawl return spring, and pawl release lever are shown according to one embodiment.

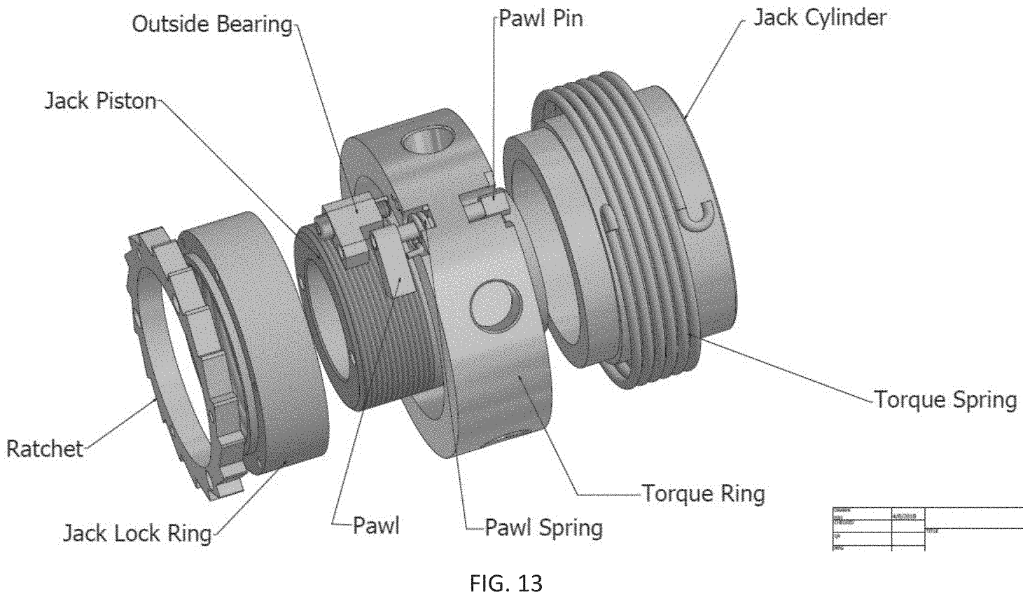

With reference now to FIG. 13, a jack piston, jack cylinder, torque spring, torque ring, jack lock ring, and related components are shown according to one embodiment.

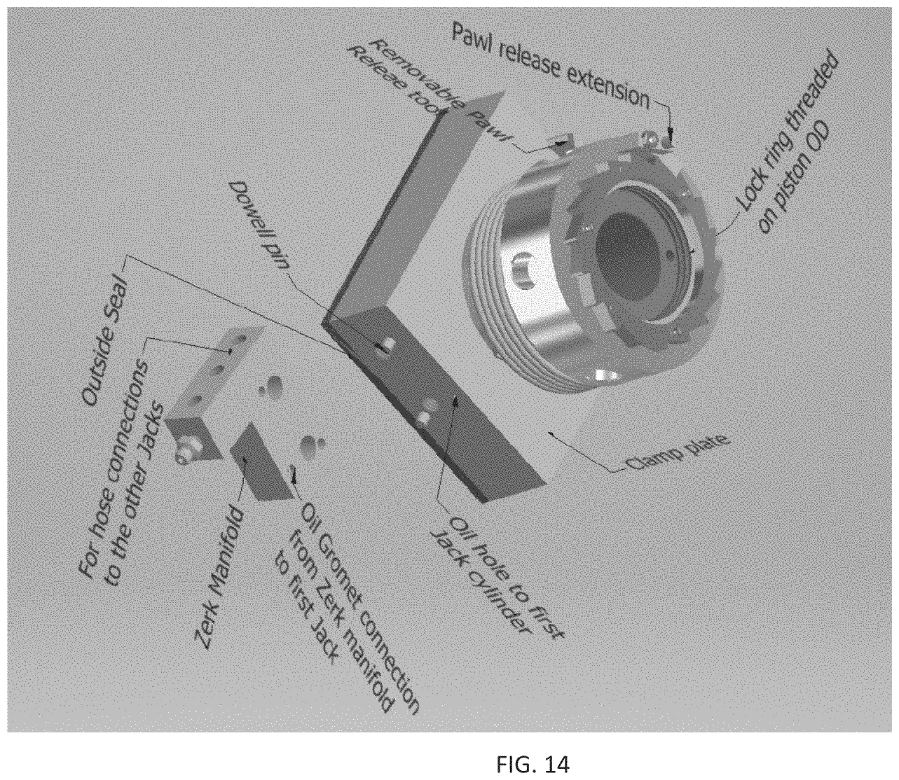

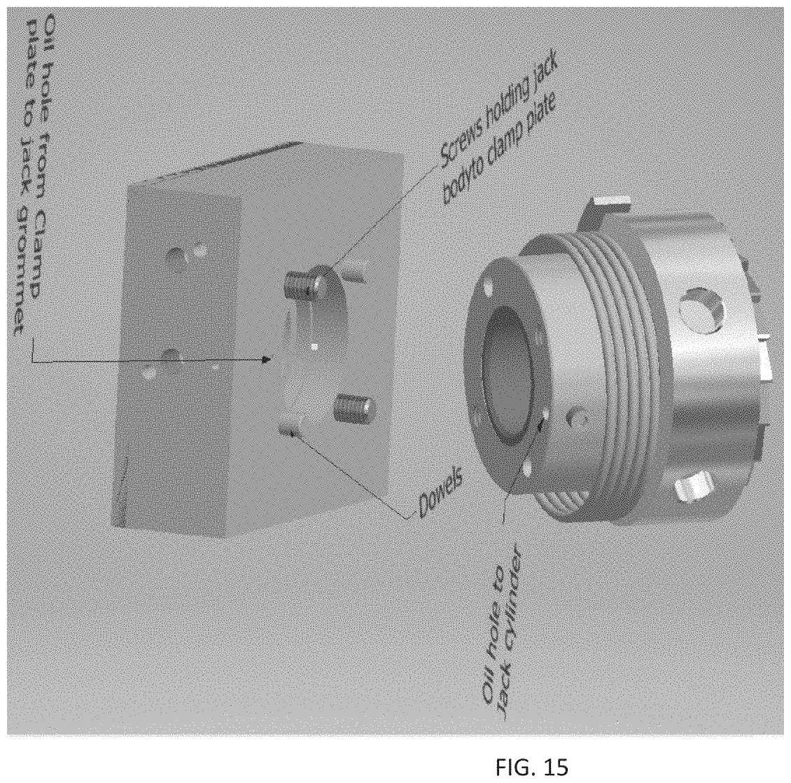

With reference now to FIG. 14-15, hydraulic channels for fluid communication with the jack cylinders are shown according to one embodiment.

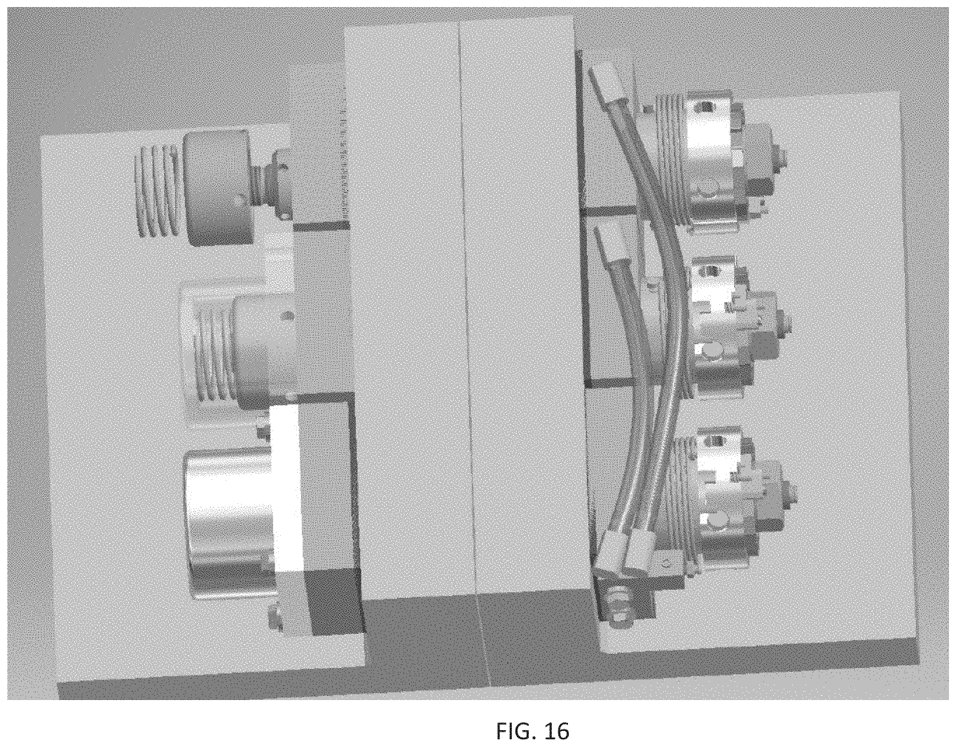

With reference now to FIG. 16-18, an assembled fastening management system is shown according to one embodiment.

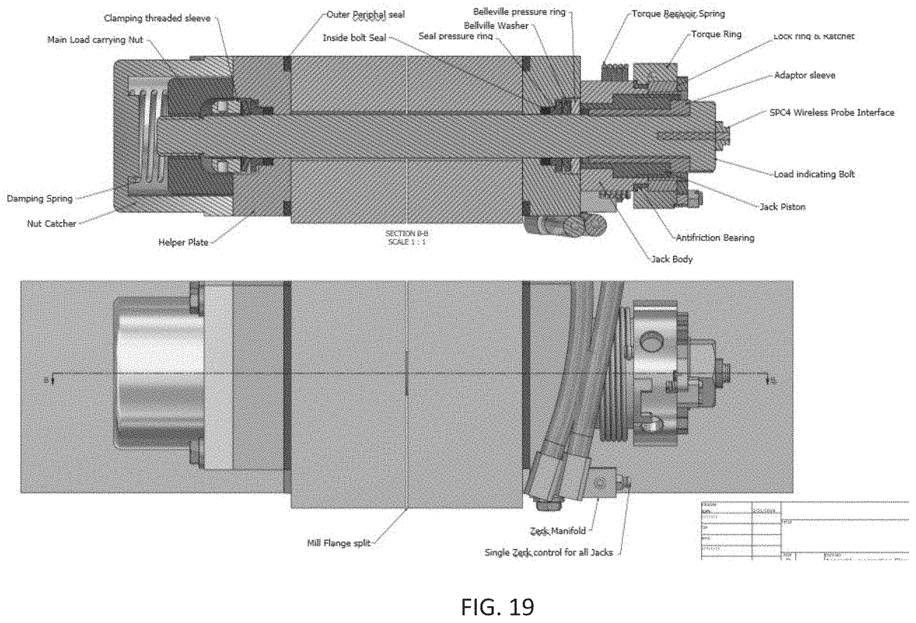

With reference now to FIG. 19, an alternative embodiment of a fastening management system is shown.

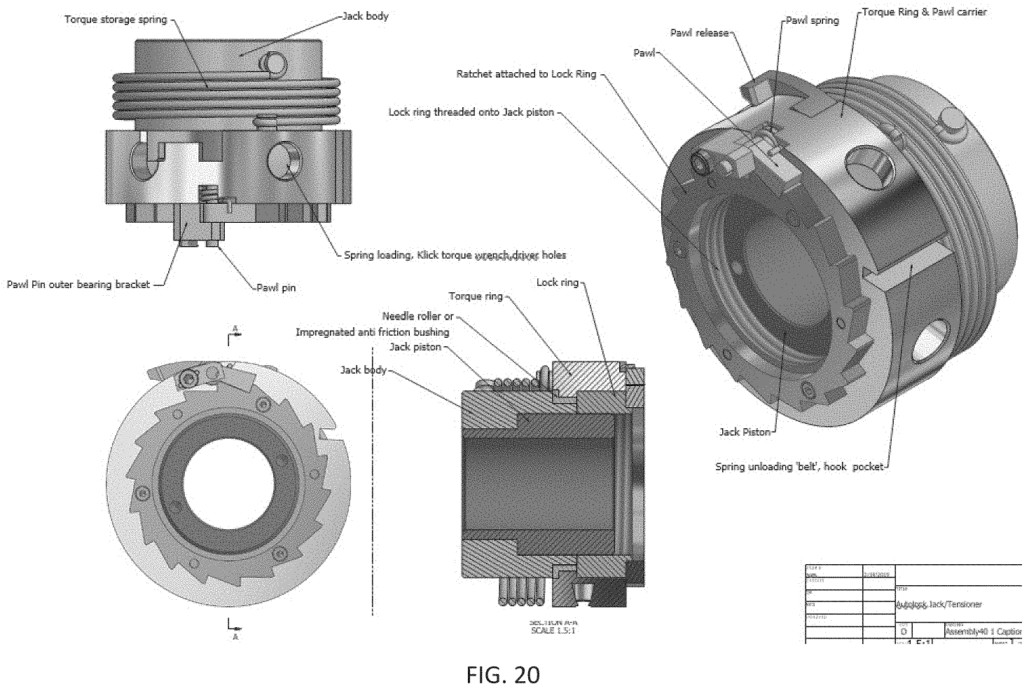

With reference now to FIG. 20, another alternative embodiment of a fastening management system is shown.

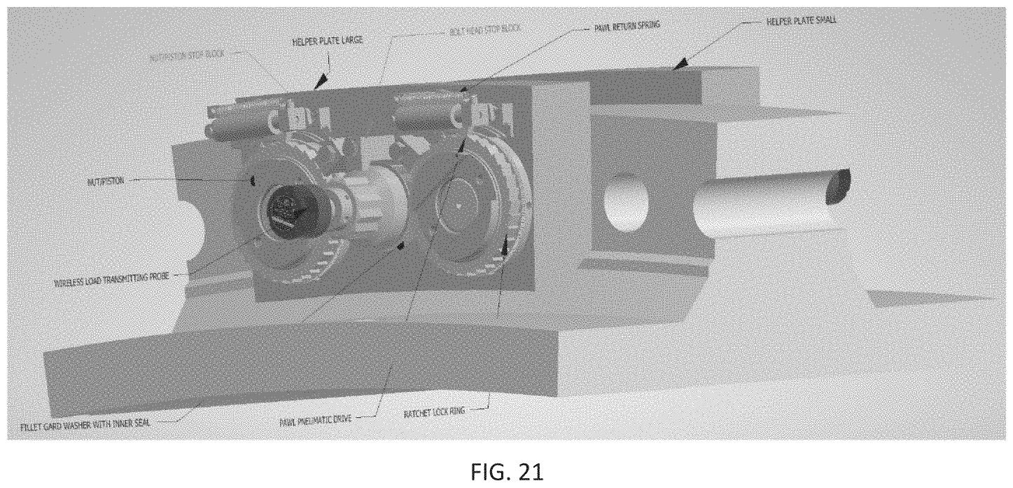

With reference now to FIG. 21, another alternative embodiment of a fastening management system is shown.

In some implementations, multiple flange bolts can be simultaneously preloaded, using hydraulic tensioners/nuts with a remote-controlled lock ring. Hydraulic cylinders may be made integral and machined into helper plates, which enables internally drilled oil holes (eliminating hoses), while also lessening the assembly width while fitting into existing mill flange hole spacing. Load monitoring of the assembly may be achieved using load indicating fasteners and wireless transmitters to provide mine operators loading data for individual bolts in real time. This real time information on flange assembly tightness is invaluable to plan and schedule maintenance shutdowns. It also allows for a closed-loop automatic tightening software program whereby all fasteners are pulled up and verified to target values that are fed back from each bolt.

Thus, remote-controlled lockrings for hydraulic jacks and nuts may be configured as a spring loaded version mounted on the jack, a pneumatic style with a bracket mounted to the jack, or as a ratchet drive bracket mounted to the helper plate to manage a flange fastening.

A number of implementations of the invention have been described. Nevertheless, it will be understood that various modifications may be made without departing from the spirit and scope of the invention. Accordingly, other implementations are within the scope of the following claims.

Finally, while the present invention has been described above with reference to various exemplary embodiments, many changes, combinations and modifications may be made to the exemplary embodiments without departing from the scope of the present invention. For example, the various components may be implemented in alternative ways. These alternatives can be suitably selected depending upon the particular application or in consideration of any number of factors associated with the operation of the device. In addition, the techniques described herein may be extended or modified for use with other types of devices. These and other changes or modifications are intended to be included within the scope of the present invention.

I claim:

1. A lock ring tightening mechanism comprising:
a rotary pawl carrier disposed in a radial guide track and moveable by a piston connected to the rotary pawl carrier;
a ratcheting lock ring configured for rotational actuation in a tightening direction by actuation of the rotary pawl carrier by the piston;
a return spring configured to return the rotary pawl carrier to a starting position; and
wherein repeated rotational actuation of the ratcheting lock ring serves to maintain tension in a fastening.

2. The lock ring tightening mechanism of claim 1, wherein the piston is configured to stroke alternately forward and reverse to each end of one of an air cylinder and a hydraulic cylinder; and where a connecting link is configured to pull and push the rotary pawl carrier, to drive the ratcheting lock ring to tighten a fastening.

3. The lock ring tightening mechanism of claim 2, wherein a ratcheting pawl drive is mounted to a jack body and is configured with a spring-loaded “torque pack” to bias the lock ring to rotate only in one direction to remain flush with a load face of the jack body.

4. The lock ring tightening mechanism of claim 3, wherein the pawl is driven using at least one of pneumatic power and electric power to turn the ratcheting lock ring.

5. The lock ring tightening mechanism of claim 1, further comprising tensioning assemblies to prevent broken parts from detaching from a rotating mill when a bolt breaks.
